(19) United States
(12) Patent Application Publication
(10) Pub. No.: US 2005/0076720 A1
(43) Pub. Date: Apr. 14, 2005

(54) Method and device for integrated cable signal adjustment

(75) Inventors: Johan Falk, Molndal (SE); Annika Lidstrom, Goteborg (SE)

Correspondence Address: BURNS DOANE SWECKER & MATHIS L L P, POST OFFICE BOX 1404, ALEXANDRIA, VA, 22313-1404, US

(73) Assignee: Aktiebolaget SKF, Goteborg (SE)

(21) Appl. No.: 10/921,309

(22) Filed: Aug. 19, 2004

(30) Foreign Application Priority Data
Aug. 19, 2003 (SE) 0302239-9

(51) Int. Cl. G01L 3/02

(52) U.S. Cl. 73/862.391

(57) ABSTRACT

A method and a device for integrated cable signal adjustment is employed when mounting a bearing on a shaft, whereby strain is measured at the bearing ring while it is driven along the shaft, and the instantaneous clearance reduction in the bearing is calculated based on the measured strain, with the clearance reduction being used to determine the amount the bearing should be driven along the shaft. A systematic measurement error in the form of a too high measurement result appearing when the strain measurement takes place on the side face of the bearing ring is compensated for using a compensating device connected in a cable extending between a sensor fitted to the point of measurement and an indicator displaying the measurement result. The compensating device lowers the measurement signal before reaching the indicator, with a factor corresponding to the measurement error.

This application is based on and claims priority under 35 U.S.C. § 119 with respect to Swedish Application No. 0302239-9 filed on Aug. 19, 2003, the entire content of which is incorporated by reference.

### FIELD OF THE INVENTION

The present invention generally relates to bearings. More particularly, the invention pertains to a method and a device for integrated cable signal adjustment for compensating predictable or systematic measurement errors particularly during mounting of a bearing on a shaft.

### BACKGROUND DISCUSSION

When mounting rolling bearings, particularly when mounting on tapered seats, there is a requirement that the bearing must be mounted with an interference fit on a shaft or adapter sleeve. To ascertain that the bearing ring has been driven up a required distance, a method has been previously suggested in EP 0 688 967 B1 U.S. Pat. No. 5,685,068), the entire disclosure of which is incorporated herein by reference. In this proposed method, the strain is measured at least at one side face of the bearing during the time the ring is driven up axially, and the instantaneous clearance reduction in the bearing is calculated. This clearance reduction is used for determining the distance the bearing should be driven up along the shaft.

The strain is measured by way of a sensor, preferably in the form of a strain gauge, and the signals representing the changes in strain in the bearing ring are supplied via a cable to a calculator arranged to calculate on the basis of the known initial clearance and the signals from the sensor, the instantaneous nominal clearance reduction and the value of the initial clearance, which is shown on a display. This combined calculator and display is often a hand-held indicator.

During development of this method, a simplification has been chosen where a larger systematic error is accepted due to geometrical factors. According to this simplification, the same compensation factor is used independent of which bearing is to be mounted.

However, different types of bearings will not permit mounting of the sensor on the side face and for this reason either side-mounted sensors or top-mounted sensors are used, i.e. in the area of the outer envelope surface of the inner bearing ring axially outside the race tracks for the rolling bodies.

Extensive tests have shown that there is a systematic error which gives a value deviating 6% to 7% between measurements with the two different locations of the sensors, with the side face location being given a higher value. The difference is dependent on the fact that the measurement takes place nearer to the shaft, whereas about half the difference is attributable to other edge effects. The dispersion error is also bigger at a sensor mounted at the side face.

When using the described method for mounting a bearing where the sensor is positioned on the side face of the bearing ring, this error will give an excessively loose fit of the bearing, which can lead to a premature bearing failure. Such a bearing failure can result in extensive economical losses and may even cause loss of human lives.

It is certainly possible to make manual settings in the indicator from a technical point of view, but such a solution incorporates an increased risk for human errors. From a safety point of view, it is therefore desirable to have a relatively uncomplicated method which does not require any manual settings, for eliminating the risk for errors caused by inadvertent handling of the equipment.

It would thus be desirable to develop a relatively simple method and associated device for compensating for the systematic error in measuring results caused in the manner described above, in a manner with reduced risk for incorrect handling. The compensation desired is that the 6% or 7% deviation between the values at measurement with top-mounted sensor and with side-mounted sensor should be reduced.

A possibility would of course be to arrange for an individual setting in the indicator for different bearing types, and particularly for different positions of fitting the sensor to the bearing. However, this is a solution which is not applicable with the indicators presently in use, and such a solution would also most likely cause a cost increase.

### SUMMARY

A method and a device are provided to compensate for the systematic measurement error mentioned above in a relatively simple and cost efficient manner, with only marginal cost increase.

According to one aspect, a method is provided for integrated cable signal adjustment when mounting a bearing with a taper bore on a shaft, whereby strain is measured at a bearing ring of the bearing as the bearing ring is driven up axially on the shaft, and instantaneous clearance reduction in the bearing is calculated based on the measured strain, with the clearance reduction in the bearing being used to determine an amount the bearing should be driven along the shaft. The method comprises compensating for a systematic measurement error in a form of a too high measurement signal which appears when strain measurement takes place on a side face of the bearing ring instead of on an outer peripheral surface of the bearing ring through use of a compensating device connected in a cable between a sensor fitted to a point of measurement and an indicator displaying a measurement result. The compensating device lowers the measurement signal before reaching the indicator with a factor corresponding to the measurement error.

According to another aspect, a method is provided for effecting adjustment of a signal from a sensor fitted to a side face of a bearing ring of a bearing having a taper bore when mounting the bearing on a shaft, with the sensor measuring strain at the bearing ring as the bearing ring is driven along the shaft and instantaneous clearance reduction in the bearing being calculated based on the measured strain, and with the clearance reduction in the bearing being used to determine an amount the bearing should be driven along the shaft. The method comprises lowering measurement signals produced by the sensor before measurement results associated with the measurement signals are displayed on a display of an indicator which is connected to the sensor by a cable, with the measurement signals being lowered through operation of a compensating device connected in the cable to compensate for the measurement signals being too high due to the sensor being fitted to the side face of the bearing ring.

An arrangement for integrated cable signal adjustment when mounting a bearing with a taper bore on a shaft comprises a sensor fitted at a side face of an inner race ring of the bearing which measures strain at the inner race ring as the inner race ring is driven up axially on the shaft, with an instantaneous clearance reduction in the bearing being calculated based on the measured strain, and the clearance reduction being used to determine an amount the bearing should be driven along the shaft. In addition, a cable extends from the sensor to an indicator provided with a display, with the indicator receiving measurement signals from the sensor, and a compensating device is connected in the cable to lower measurement signals reaching the indicator to compensate for a signal deviation caused by the sensor being fitted at the side face of the inner race ring instead of on an outer envelope surface thereof.

### BRIEF DESCRIPTION OF THE DRAWING FIGURES

The foregoing and additional aspects of the disclosed subject matter will become more apparent from the following detailed description considered with reference to the accompanying drawing figures in which like elements are identified by like reference numerals.

FIG. 1 is a perspective view of a portion of a spherical roller bearing, under a mounting sequence with use of the earlier known method and equipment.

FIG. 2 is a cross-sectional view of a part of a toroidal roller bearing.

FIG. 3 is a perspective view a device according to an embodiment of the present invention which includes the compensating device.

FIG. 4 is a plan view the device shown in FIG. 3.

FIG. 5 is a schematic illustration of one form of the integrated cable signal adjuster used in the compensating device.

### DETAILED DESCRIPTION

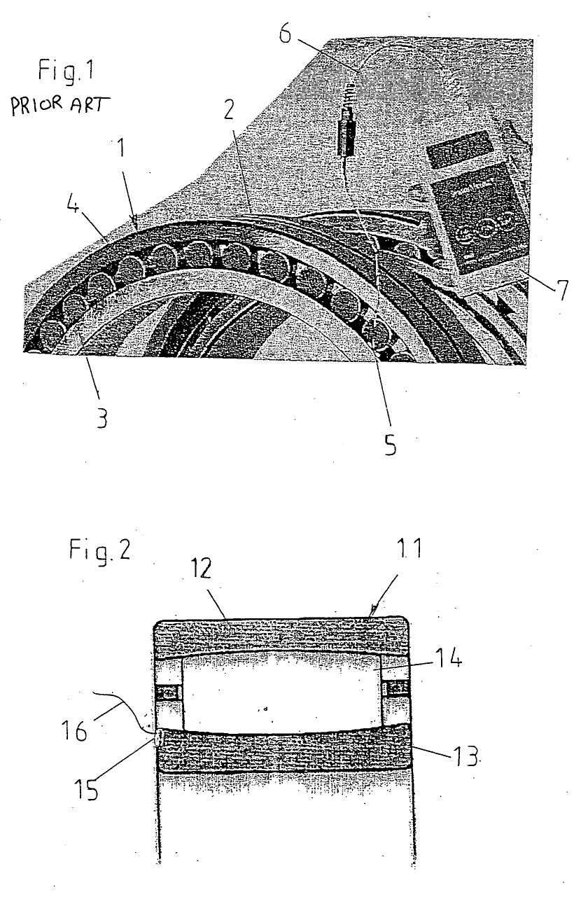

FIG. 1 illustrates in perspective view a portion of a spherical roller bearing 1 having an outer race ring 2 ,an inner race ring 3 and a plurality of spherical rollers 4 arranged between the outer and inner race rings 2, 3. The spherical configuration permits the outer race ring 2 to make angular movements relative to the rollers, by which misalignment can be compensated. However, the positions of the rollers 4 are substantially constant in relation to the inner race ring 4, and for this reason it is possible to fit a sensor 5 on the land of the race ring, i.e. in the area outside the portion of the outer envelope or peripheral surface of the inner race ring, which is occupied by the rollers. The sensor 5 is connected via a cable 6 with an indicator 7, which continuously shows on its display during the mounting procedure a value representing the current internal clearance reduction divided by the bore diameter. The indicator is adapted to show a correct value when the sensor 5 is fitted to the inner race ring in the manner described, i.e. mounted on the outer envelope or peripheral surface of the inner ring 3.

FIG. 2 illustrates in cross-section a part of a toroidal bearing 11, having an outer race ring 12, an inner race ring 13 and toroidal rollers 14 positioned between the inner and outer race rings 12, 13. A bearing of this type as known performs in a different manner than the spherical roller bearing, as its race rings 12, 13 and its rollers 14 have the ability to move relative to each other both angularly and also axially. This means that there is no space available for mounting a sensor on the outer envelope or peripheral surface of the inner ring, as the rollers can move axially along the entire axial extension of the inner race ring. As schematically illustrated in FIG. 2, the sensor 15 instead has been fitted on the side face of the inner race ring, where it can also measure the variation in strain in the ring during mounting of the bearing 11, and which via a cable 16 transfers signals representative for the strain in the bearing ring to an indicator.

As mentioned above, such a difference in the position of the sensor will give a measurement value, which value is 6% to 7% higher than that of the top-mounted sensor 5. If the operator mounting the bearing uses the value shown in the indicator, in the same manner as when the sensor was top-mounted, the bearing should likely have a too loose fit for the bearing.

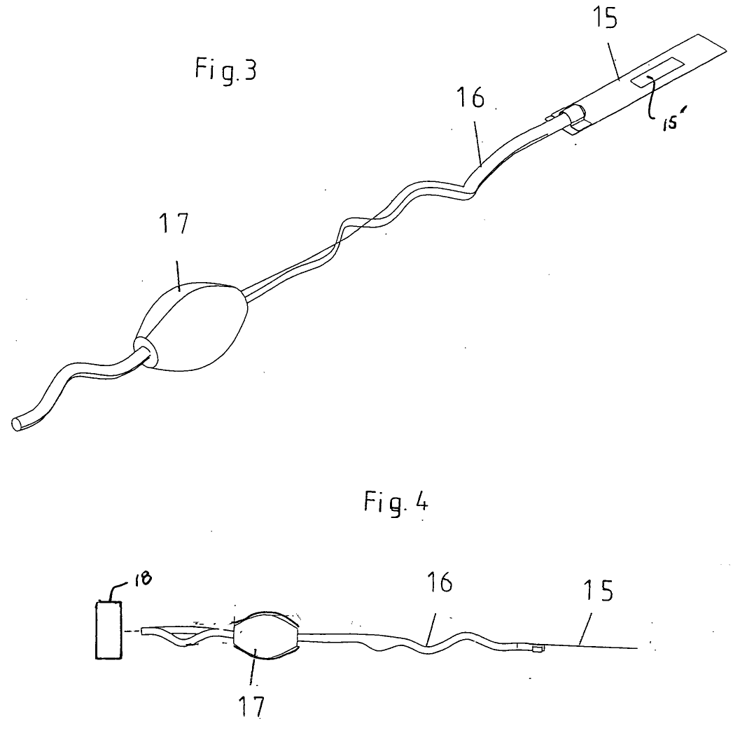

FIG. 3 is a perspective view of a sensor used in accordance with an embodiment of the invention, while FIG. 4 illustrates the sensor in planar view. The sensor 15 is preferably a thin foil equipped with strain gauges. FIG. 3 schematically illustrates strain gauges 15′ equipped on a thin foil. The sensor 15 is attached to a signal cable 16, which is connected to and delivers signals representative for the current strain in the bearing ring 13 to an indicator or measuring instrument which can be of the same type as the one illustrated in FIG. 1. An indicator 18 connected to the cable 16 is schematically shown in FIG. 4.

The cable 16 is provided with a compensating device 17 arranged to automatically lower the signal for the side-face-mounted sensor 15 as compared to the top-mounted sensor 5, with a value corresponding to the 6%-7%, which according to the above mentioned tests has been found to be a systematic error between the two different mounting manners.

Thus, a method and device are provided for effecting integrated cable signal adjustment when mounting a taper-bored bearing on a shaft through measurement of strain at a bearing ring of the bearing as the bearing ring is driven up axially on the shaft, with the instantaneous clearance reduction in the bearing being calculated based on the measured strain and the clearance reduction in the bearing being used to determine the amount the bearing should be driven along the shaft. Systematic measurement error in the form of too high measurement signals associated with the strain measurement taking place on the side face of the bearing ring is compensated for by providing the compensating device that is connected in the cable between the sensor and the indicator which displays the measurement results. The compensating device lowers the measurement signal before reaching the indicator with a factor corresponding to the measurement error.

Thus, with this described arrangement and method, the required or desired compensation is effected not in the sensor 15 and not in the indicator connected thereto via the cable 16, but rather in the cable itself.

The use of passive electric components in the compensating device is preferred, but to provide a resistor in parallel with the strain gauge will cause a non-linearity and a complete displacement of the basic resistance.

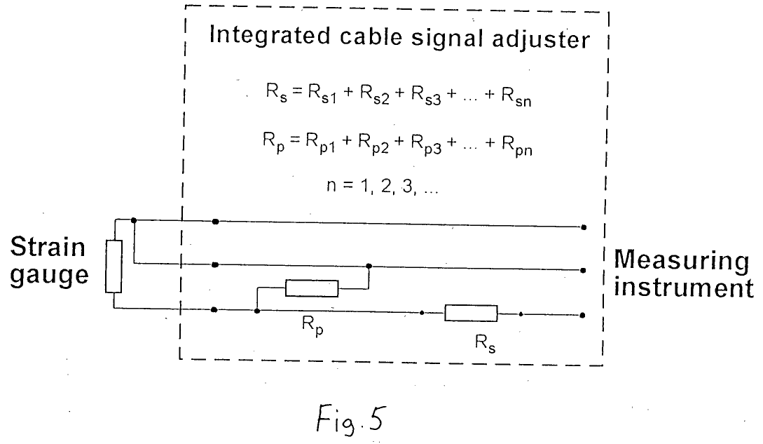

However, it has been found that a structure consisting of one resistor connected in series with the senor or sensor components and one resistor connected in parallel with the sensor or sensor components will give a structure consisting only of passive electric components and which is substantially linear in the area where the strain gauge is working. FIG. 5 schematically illustrates such an arrangement of an integrated cable signal adjuster incorporated in the compensating device 17.

This cable signal adjuster including one resistor in series and one resistor in parallel is preferably enclosed, for instance in a plastic casing (e.g. by molding), to form the compensation device 17. The compensating device 17 is thus made integral and in one piece with the sensor 15 and the cable 16, thus preventing the device from being altered by the user. Also, to protect the compensating device from oil and contaminations during production and transport, the device can be enclosed in a shrink film package.

The basic resistance of the strain gauge is about 350 Ω, and the variation within the range used here is at most about 0.8 Ω. The reduction of interest is between about 5% to 15%, particularly about 7%, and this corresponds to a parallel resistance of between 10000 Ω and 20000 Ω, and this range is very favorable from a linearity aspect.

With the method and the device described above, a compensation factor adapted to each specific bearing is realized, and the mounting procedure is relatively safe, even if the mounting is made by personnel who are not experts, as the indicator will display the actual values of the clearance reduction.

The principles, preferred embodiment and mode of operation have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A method for integrated cable signal adjustment when mounting a bearing with a taper bore on a shaft, whereby strain is measured at a bearing ring of the bearing as the bearing ring is driven up axially on the shaft, and instantaneous clearance reduction in the bearing is calculated based on the measured strain, with the clearance reduction in the bearing being used to determine an amount the bearing should be driven along the shaft, the method comprising:
compensating for a systematic measurement error in a form of a too high measurement signal which appears when strain measurement takes place on a side face of the bearing ring instead of on an outer peripheral surface of the bearing ring through use of a compensating device connected in a cable between a sensor fitted to a point of measurement and an indicator displaying a measurement result; and
the compensating device lowering the measurement signal before reaching the indicator with a factor corresponding to the measurement error.

2. The method according to claim 1, wherein the compensating device comprises passive electric components.

3. The method according to claim 2, wherein the passive electric components are resistors.

4. The method according to claim 3, wherein the resistors include at least one resistor connected in series and at least one resistor connected in parallel.

5. A method for effecting adjustment of a signal from a sensor fitted to a side face of a bearing ring of a bearing having a taper bore when mounting the bearing on a shaft, with the sensor measuring strain at the bearing ring as the bearing ring is driven along the shaft and instantaneous clearance reduction in the bearing being calculated based on the measured strain, and with the clearance reduction in the bearing being used to determine an amount the bearing should be driven along the shaft, the method comprising:
lowering measurement signals produced by the sensor before measurement results associated with the measurement signals are displayed on a display of an indicator which is connected to the sensor by a cable; and
the measurement signals being lowered through operation of a compensating device connected in the cable to compensate for the measurement signals being too high due to the sensor being fitted to the side face of the bearing ring.

6. The method according to claim 5, wherein the compensating device lowers the measurement signals through use of passive electric components.

7. The method according to claim 5, wherein the compensating device lowers the measurement signals through use of resistors.

8. The method according to claim 5, wherein the compensating device lowers the measurement signals through use of at least one resistor connected in series to the sensor and at least one resistor connected in parallel to the sensor.

9. An arrangement for integrated cable signal adjustment when mounting a bearing with a taper bore on a shaft, comprising
a sensor fitted at a side face of an inner race ring of the bearing which measures strain at the inner race ring as the inner race ring is driven up axially on the shaft, with an instantaneous clearance reduction in the bearing being calculated based on the measured strain, and the clearance reduction being used to determine an amount the bearing should be driven along the shaft;
a cable extending from the sensor to an indicator provided with a display, the indicator receiving measurement signals from the sensor; and
a compensating device connected in the cable to lower measurement signals reaching the indicator to compensate for a signal deviation caused by the sensor being fitted at the side face of the inner race ring instead of on an outer envelope surface thereof.

10. The device according to claim 9, wherein the compensating device comprises passive electric components.

11. The device according to claim 9, wherein the compensating device comprises resistors.

12. The device according to claim 11, wherein the resistors comprise one resistor connected in series with the sensor and another resistor connected in parallel with the sensor.

13. The device according to claim 9, wherein the compensating device is enclosed in a casing.

14. The device according to claim 9, wherein the compensating device is enclosed in a casing made of plastic material.
